(19) United States
(12) Patent Application Publication
(10) Pub. No.: US 2011/0223387 A1
(43) Pub. Date: Sep. 15, 2011

(54) NON-PVC TYPE CALENDERED POLYOLEFIN SHEET AND THE PROCESS THEREOF

(76) Inventors: Dein-Run FUNG, Taipei County (TW); Te-Chao Liao, Taipei County (TW); Chun-Lai Chen, Taipei County (TW)

(21) Appl. No.: 12/723,395

(22) Filed: Mar. 12, 2010

(51) Int. Cl. B32B 3/10; B29C 59/04

(52) U.S. Cl. 428/172; 264/175; 428/156

(57) ABSTRACT

The present invention relates to a non-PVC type calendered polyolefin sheet and the preparation process thereof, characterized in that a polyolefin material composition which is different from polyvinyl chloride (PVC) is processed by the calendering process to produce polyolefin plastic sheets; the process includes that first of all raw materials are evenly blended in a mixer, homogeneously melt-mixed in Banbury mixer, then fully gelled in a roll mill, thereafter calendered in a calender into the sheet which can be pattern-embossed with a set of embossing rolls if necessary, finally the sheet product is cooled down to fix the pattern.

### FIELD OF THE INVENTION

The present invention relates to a non-PVC type calendered polyolefin composition which can be used in a traditional PVC sheet calendering process.

### BACKGROUND ART

In recent years, countries around the world emphasized more and more on environmental issues, in order to solve this long-standing environmental problems, and developed countries are scheduled to have environmental regulations to ask all industries gradually to restrict or recyde various plastic products, for example, the EU has in its relevant laws of the packaging materials and plastic products and components to ban certain heavy metals, polyvinylchloride (abbreviated as PVC) or styrene and other ingredients with a view to reduce the environment impact of the said components. In addition, to keep an environmentally friendly image, a number of world-renowned enterprises also announce their voluntary PVC restriction policies, including packaging materials, building materials, and spare parts, etc.

Therefore, the use of other environmentally-friendly plastic materials is suggested, such as in ROC Patent No. I280914, the composition of Polyethylene (abbreviated as PE), ethylene-vinyl acetate copolymer (abbreviated as EVA) or polyethylene-vinyl acetate copolymer blend (abbreviated as PEVA) is used to manufacture embossed plastic sheets via T-die casting. Due to the difference between the material properties of PE, EVA or PEVA, etc. (collectively referred as polyolefin) and PVC, the traditional embossed PVC sheet (film) manufacturing methods can not be used to produce PE, EVA or PEVA embossed sheet having the same quality as PVC, therefore a new equipment (T-die casting machine) must be purchased or the traditional embossed PVC sheet (film) production equipment should be substantially modified to handle polyolefin.

The calendering process is the most economic and efficient method for manufacturing a traditional embossed PVC sheet or film with a thickness of 0.02 to 2.0 mm. The calendered PVC sheet or film can immediately be thermoformed into all kinds of shapes, including the wide application of packaging, pond and swimming pool liners, flat arts, surface plaques, stationery, or products such as floor tiles. Although the T-die casting process can produce a superior-quality sheet or film, the T-die casting process can not compare with the calendaring process in the field of yield and economic advantages.

PE, EVA or PEVA material is tough, but the melt strength of PE, EVA or PEVA material is not good enough at high temperature, the molten plastic sags or breaks down easily when it is withdrawn from the calendar roll, and can not be heat-embossed and thermoformed. Thus PEVA sheet is generally processed with a T-die casting method wherein the plastic material is extruded through the T-die, a plane-shaped sheet or film is created, and then it is cooled for the shape forming, and drawn through a set of heated embossing rolls for embossing, thereafter it is cooled down immediately.

When the general PE, EVA or PEVA sheet is made by a calendaring process, PE, EVA or PEVA material shows good malleability, but poor elasticity, the three-dimensional embossed pattern will be ambiguous due to the rolling tension, in addition, the rolling three-dimensional convex pattern will damage PE, EVA, or PEVA sheet because of the discontinuous or non-uniform strength, it will easily be torn in the embossed position. If the polyolefin material is calendered, its high viscous melt easily sticks on the roll to increase torque, and shows a poor processability, thereby how to develop a polyolefin composition able to be calendered to obtain a clear three-dimensional embossed surface with an uniform structural strength becomes a research topic to which the industry is devoted.

### DETAILED DESCRIPTION OF THE INVENTION

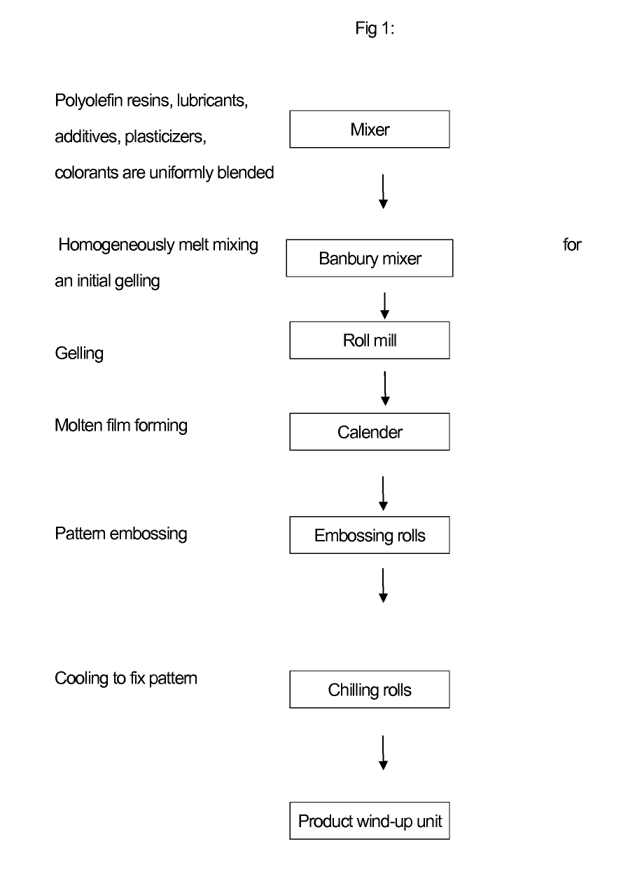

The polyolefin material formulation composition should be specially studied in accordance with different processing methods such as extrusion, injection, calendering, etc. and different molding conditions. In order to overcome the shortcomings of the previous technology—the low surface three-dimensional embossed pattern resolution and the non-uniform structural strength of the non-PVC resin, based on the inventor's experiment and exploration, first a formulation of a special polyolefin composition and other auxiliary additives are blended in a mixer and then homogeneously mixed in Banbury mixer (100 L×300 HP, made by NPC) into an initial gelled melt, and then fully gelled in a roll mill (26×84×150 HP, made by NPC), the gellation process is shown in FIG. 1. When the resin is gelled, then it is calendered smoothly into a plastic film.

The main purpose of the present invention is to provide a non-PVC type polyolefin composition which can also be directly processed in a traditional PVC calendaring process to obtain sheet or film with a variety of thickness, soft and hard feeling, smooth flat or three-dimensional embossed surface, and uniform structural strength.

The process includes: the non-PVC type polyolefin mixture and other additives are first blended in a mixer, then homogeneously molten in Banbury mixer and fully gelled in a roll mill, finally calendered into polyolefin plastic sheets. The resulted polyolefin plastic sheets are recyclable and less polluting to the environment.

The inventive polyolefin composition can directly be processed into a polyolefin sheet with a traditional PVC film process without adding or modifying the existing equipments, therefore the present inventive polyolefin composition can be turned into plastic film or sheet with low processing cost, faster production speed and environmental protection advantages.

The inventive polyolefin plastic sheets have the thickness range of 0.02˜2.0 mm with a different stiffness which is made of the polyolefin composition with a special formulation.

The process to manufacture the present inventive polyolefin plastic sheets includes at first the polyolefin composition and the additives are blended with a mixer, then homogeneously mixed in Banbury mixer and gelled in a roll mill at a temperature controlled in the range of 130˜200° C., finally calendered with a traditional PVC film process, thereby polyolefin plastic sheet can be obtained with the simple processing process, low-cost equipments and advantages of fast production.

The present inventive process can also be in accordance with the performance requirement of a variety of plastic sheets to add lubricants, antioxidants, ultraviolet absorbers, fire retardants, antistatic agents, fillers, colorants and other modifiers.

Accordingly, the inventive polyolefin sheet is obtained by the following steps:

(1) 100 PHR (Parts per Hundred of Resin by weight) of the polyolefin resin composition and
0.1˜15 PHR of lubricants, 0.1˜50 PHR of plasticizers, 0.1˜80 PHR of additives (including modifiers, antioxidants, anti-bacterial agents, fire retardants, fillers, dispersion agents and UV absorbers) and 0.0˜15 PHR of pigments are blended in a mixer, then homogeneously molten in Banbury mixer.

(2) The molten mixture is gelled by a roll mill with a temperature controlled at 130˜200□,
then it is calendered into a hot melt sheet having a thickness controlled between 0.05 mm ˜2.0 mm.

(3) The plastic sheet is introduced or not introduced into a set of embossing rolls to press or
not to press the necessary embossed pattern, and

(4) then plastic sheet is cooled in chilling rolls to fix the pattern and wound up.

The invention makes the use of the combination of different polyolefin resins having different viscosities to make it suitable for the film calendering process. The used polyolefin resin composition consists two kinds or more than two kinds of plastics selected from the non-PVC type PE (Polyethylene), PP (Polypropylene), EVA (Ethylene-vinyl acetate copolymer), TPO (Thermtoplastic polyolefin) or TPE (Thermoplastic elastomer).

Of these, Polyethylene (PE) can be High Density Polyethylene (HDPE), Low Density Polyethylene (LDPE), Linear Low Density Polyethylene (LLDPE) or metallocene Polyethylene (mPE).

Polypropylene (PP) includes polypropylene homopolymer (PP-H), Polypropylene copolymer (PP-B), random copolymer polypropylene (PP-R).

Ethylene-Vinyl acetate copolymer (EVA) is basically an EVA having 8˜28% vinyl acetate content.

Thermoplastic plastic elastomer (TPE) is a dynamically vulcanized polyolefin type TPE, a blend of block copolymer PP and thermoplastic polyolefin type TPE, or polyamide type TPE, fluorine-containing TPE, functional groups possessed SEBS type TPE.

Thermoplastic polyolefin (TPO) is an olefin type TPO, including a blend of polypropylene (PP) and ethylene propylene diene rubber (EPDM), ethylene-octene copolymer, ethylene-butene copolymer, ethylene-propylene copolymer, or ethylene-a-olefin copolymer and so on.

The use of lubricants is very important to the polyolefin resin calendaring process, and the lubricants in a high temperature molten state should not be sticky to the metal surface of calendar rolls. The lubricants used in the present invention is stearic acid type, fatty acid ester type, fatty acid amide type, paraffin hydrocarbon type, metal soap type, silicone type lubricants, alone or the mixture thereof.

Plasticizers can be incorporated in the present invention to adjust stiffness and processing slipness, the plasticizers include non-phthalate type plasticizers, polyester polymer plasticizers, processing oils, wherein non-phthalate type plasticizers are selected from aromatic carboxylic ester, hexahydrophthalate, citric acid ester, phenyl sulfonic acid ester, phosphate ester type, epoxy type, aliphatic diacid ester type; polymeric polyester plasticizers can be chosen from polysebacic acid acrylic ester, processing oils can be selected from paraffin-based oil, naphthenic oil, or aromatic oil.

For different requirements of the polyolefin plastic sheet material, various additives including: modifiers, antioxidants, antimicrobial agents, fire retardant agents, fillers, dispersion agents and UV absorbers, alone or the mixture thereof are added, wherein modifiers are selected from: methyl methacrylate-butadiene-styrene copolymer, ethylene-vinyl acetate copolymer; antioxidants are selected from: hindered phenols, phosphates; antibacterial agents are organic arsenic, silver ion antimicrobial agent; fire retardant agents are: phosphorus-containing compounds (such as phosphate flame retardant agents, ammonium phosphate fire retardant agents, aromatic phosphate compounds), nitrogen fire retardant agents, metal hydrogen oxide (such as magnesium hydroxide, aluminum hydroxide), zinc borate; fillers are chosen from: calcium carbonate, clay, talc, mica, limestone, silica powder; dispersing agents are selected from: silane coupling agents, zirconium aluminum coupling agents; ultraviolet absorbent are selected from hydroxyl dibenzotriazole type UV absorbers, or hydroxy benzophenone type UV absorber, alone or the mixture thereof.

Depending on the color hue requirements, colorants can be added, it can be organic or inorganic pigments or the mixture thereof, or the polyolefin film can be transparent without colorants.

In applications, the inventive polyolefin film can be a single layer sheet, but also it can be heated at a temperature controlled at 80□˜180□, then laminated into a multi-layer product.

### EXAMPLES

The invention is described in more specific embodiments by the following better examples, without restricting the scope of the inventive technology and claim in any way whatsoever.

### Example 1

The process to manufacture the polyolefin plastic sheets having 0.09 mm thickness includes:
(1) The formulation 1 in accordance with Table 1 containing a mixture of polyolefin resins (EVA with VA content of 8˜28%), lubricants, plasticizers, additives (including modifiers, fire retardant agents, fillers and ultra-violet absorbents) and other raw materials is evenly blended in a mixer, then homogeneously molten in Banbury mixer;
(2) The resulted melt is gelled in a roll mill with a temperature controlled at 130□˜200□,
   then it is calendered into molten polyolefin plastic sheets having the thickness of 0.09 mm,
(3) It is introduced or not introduced into a set of embossed rolls to press or not press to form the desired pattern; and
(4) The sheet is introduced into a set of chilling rolls to fix the pattern and the inventive polyolefin sheet having 0.09 mm thickness is wound up, which shows tensile strength 65.2 kg/cm² in MD (machine direction) and 45.4 kg/cm² in CD (cross direction); MD elongation 861%, CD elongation 1010%; and MD tear strength 35.2 kg/cm², CD tear strength 37.0 kg/cm². Its feel is good with a genuine leather flexibility.

### Example 2

Utilizing the procedure of Example 1, the polyolefin plastic sheet with 0.15 mm thickness is prepared according to the formulation 2 listed in Table 1. The mechanical properties of the resulted polyolefin plastic sheet are as following: tensile strength MD 63.4 kg/cm², CD 49.8 kg/cm²; elongation MD 684%, CD 987%; and tear strength MD 35.4 kg/cm², CD 36.2 kg/cm². Its feel is good with a genuine leather flexibility.

### Example 3

Utilizing the procedure of Example 1, the polyolefin plastic sheet with 0.2 mm thickness is prepared according to the formulation 3 listed in Table 1. The mechanical properties of the resulted polyolefin plastic sheet are as following: tensile strength MD 126.7 kg/cm², CD 116.7 kg/cm²; elongation MD 500%, CD 690%; and tear strength MD 85.5 kg/cm², CD 72.1 kg/cm². Its feel is fair, but the genuine leather flexibility feeling is not as good as that of Example 1 & 2.

### Example 4

Utilizing the procedure of Example 1, the polyolefin plastic sheet with 0.1 mm thickness is prepared according to the formulation 4 listed in Table 1. The mechanical properties of the resulted polyolefin plastic sheets are as following: tensile strength MD 74.6 kg/cm², CD 68.9 kg/cm²; elongation MD 690%, CD 836%; and tear strength MD 40.6 kg/cm², CD 40.3 kg/cm². Its feel is fair, but the genuine leather flexibility feeling is not as good as that of Example 1 & 2.

### Example 5

Utilizing the procedure of Example 1, the polyolefin plastic sheet with 0.1 mm thickness is prepared according to the formulation 5 listed in Table 1. The mechanical properties of the resulted polyolefin plastic sheets are as following: tensile strength MD 81.2 kg/cm², CD 70.6 kg/cm²; elongation MD 719%, CD 958%; and tear strength MD 52.6 kg/cm², CD 55.8 kg/cm². Its feel is fair, and the genuine leather flexibility feeling is close to that of Example 1 & 2.

### Example 6

Utilizing the procedure of Example 1, the polyolefin plastic sheet with 0.3 mm thickness is prepared according to the formulation 6 listed in Table 1. The mechanical properties of the resulted polyolefin plastic sheets are as following: tensile strength MD 102 kg/cm², CD 62.7 kg/cm²; elongation MD 58%, CD 62%; and tear strength MD 69.0 kg/cm², CD 39.2 kg/cm². Its feel is fair, and the genuine leather flexibility feeling is close to that of Example 1 & 2.

### Example 7

Utilizing the procedure of Example 1, the polyolefin plastic sheet with 0:2 mm thickness is prepared according to the formulation 7 listed in Table 1. The mechanical properties of the resulted polyolefin plastic sheets are as following: tensile strength MD 59.1 kg/cm², CD 97.3 kg/cm²; elongation MD 524%, CD 447%; and tear strength MD 43.1 kg/cm², CD 30 kg/cm². Its feel is fair, and the genuine leather flexibility feeling is close to that of Example 1 & 2.

### Comparative Example 1

A white PEVA sheet having 0.2 mm thickness is prepared via T-die casting process. The mechanical properties of the resulted film are as following: tensile strength MD 117.6 kg/cm², CD 106.5 kg/cm²; elongation MD 650%, CD 213%; and tear strength MD 67.5 kg/cm², CD 69.3 kg/cm². Its feel is hard without flexibility.

### Comparative Example 2

A translucent. PEVA sheet having 0.09 mm thickness is prepared via T-die casting process. The mechanical properties of the resulted film are as following: tensile strength MD 75.3 kg/cm², CD 59.5 kg/cm²; elongation MD 357%, CD 326%; and tear strength MD 42.1 kg/cm², CD 58.9 kg/cm². Its feel is hard without flexibility.

TABLE 1

| | | | | | | | | | | Comparative | Comparative |
|---|---|---|---|---|---|---|---|---|---|---|---|
| | Formulation | | 1 | 2 | 3 | 4 | 5 | 6 | 7 | Example 1 | Example 2 |
| Resin | Polypropylene(PP) | | 65 | 30 | 36 | 50 | 35 | 30 | — | PEVA film | PEVA film |
| | Polyethylene(PE) | | 10 | — | 18 | — | 15 | 35 | 38 | (white) | (translucent) |
| | Thermoplastic polyolefin(TPO) | | — | 55 | 46 | — | 50 | 27 | 24 | | |
| | Ethylene-vinyl acetate | | 5 | — | — | 33 | — | — | — | | |
| | copolymer(EVA) | | | | | | | | | | |
| | Themoplastic plastic | | 20 | 15 | — | 17 | — | 8 | 38 | | |
| | elastomer(TPE) | | | | | | | | | | |
| lubricants | Stearic acid | | 0.1 | 0.2 | 0.2 | 0.2 | 0.1 | — | — | | |
| | Fatty acid amide | | 0.1 | 0.2 | 0.2 | 0.1 | — | 0.3 | | | |
| | Fatty acid ester | | 0.1 | 0.2 | 0.2 | 0.1 | — | — | 0.3 | | |
| Plasticizers | Non-phthalate plasticizer | | 2 | — | 5 | 5 | 3 | — | — | | |
| | Polyester polymer plasticizer | | 3 | 3 | 3 | 3 | 3 | — | 20 | | |
| | Processing oil | | — | 2 | 2 | — | — | — | — | | |
| Auxiliary | Modifier | Methyl | 3 | 3 | 3 | — | — | — | — | | |
| additives | | methacrylate- | | | | | | | | | |
| | | butadiene- | | | | | | | | | |
| | | styrene | | | | | | | | | |
| | | copolymer | | | | | | | | | |
| | Ultraviolet | Hydroxy | 0.3 | 0.3 | 0.3 | 0.3 | 0.3 | — | 0.15 | | |
| | absorbent | benzophenone | | | | | | | | | |
| | Fillers | Calcium carbonate | 50 | 50 | 20 | — | — | 15 | 70 | | |
| | Fire retardant | Aluminum hydroxide | 5 | 5 | 5 | — | — | 45 | — | | |
| | agents | | | | | | | | | | |

| | | | | | | | | |
|---|---|---|---|---|---|---|---|---|
| Colorants | TiO₂ | — | 5 | 5 | 5 | — | 4.5 | 4.8 |

| Processing Temperature(□) | | | 165 | 165 | 160 | 155 | 145 | 157 | 153 | 155 | 150 |
|---|---|---|---|---|---|---|---|---|---|---|---|
| Thickness(mm) | | | 0.09 | 0.15 | 0.2 | 0.1 | 0.1 | 0.3 | 0.2 | 0.2 | 0.09 |
| Hand feel(genuine leather flexibility) | | | ◯ | ◯ | □ | □+ | ◯− | □+ | ◯− | □ | □ |
| Physical properties | Tensile | MD | 65.2 | 63.4 | 126.7 | 75 | 81.2 | 102 | 59.1 | 117.6 | 75.3 |
| | strength | CD | 45.4 | 49.8 | 116.7 | 69 | 70.6 | 62.7 | 97.3 | 106.5 | 59.5 |
| | (kg/cm²) | | | | | | | | | | |
| | Elongation | MD | 861 | 684 | 500 | 690 | 719 | 58 | 524 | 650 | 357 |
| | (%) | CD | 1010 | 987 | 690 | 836 | 958 | 62 | 447 | 213 | 326 |
| | Tear stength | MD | 35.2 | 35.4 | 85.5 | 41 | 52.6 | 69 | 43.1 | 67.5 | 42.1 |
| | (kg/cm²) | CD | 37 | 36.2 | 72.1 | 40 | 55.8 | 39.2 | 30 | 69.3 | 58.9 |

Note:
1. Dosage unit:: PHR (parts per hundred resin by weight)
2. Physical properties test specification: ASTM D-638
3. Hand feeling (genuine leather flexibility): 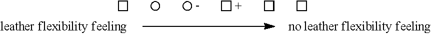 4. MD: vertical (Machine Direction)
5. CD: horizontal (Cross Direction)

1. (canceled)

2. A non-PVC type calendered polyolefin plastic sheet, wherein components thereof include:
(1) Resins: the polyolefin composition comprising two resins or more from polyethylene, polypropylene, ethylene-vinyl acetate copolymers, thermoplastic elastomers, thermoplastic polyolefins, the amount thereof is 100-PHR;
(2) Lubricants: selected from stearic acid, fatty acid ester, fatty acid amide, paraffin hydrocarbons, metal soaps, organic silicones, alone or the mixture thereof, its amount is 0.1˜15 PHR;
(3) Plasticizers: selected from non-phthalate plasticizers, polyester polymer plasticizers,
processing oils, alone or the mixture thereof, its amount is 0.1˜50 PHR;
(4) Auxiliaries: modifiers, ultraviolet absorbents, fire retardant agents, fillers, dispersion agents
etc. alone or the mixture thereof, its amount is 0.1˜80 PHR; and
(5) Colorants: TiO₂ or other colorants are added depending on the color hue demand for
products or not added for a transparent sheet, its amount is 0.0˜15 PHR.

3. The non-PVC type polyolefin plastic film of claim 2, wherein additives include modifiers, ultraviolet absorbents, fire retardant agents, fillers, dispersing agents; the said modifiers are at least one selected from the group consisting of methyl methacrylate-butadiene-styrene copolymer and ethylene-vinyl acetate copolymer; fillers are at least one selected from the group consisting of calcium carbonate, clay and silica powder; ultraviolet absorbents are at least one selected from the group consisting of hydroxy benzophenone and hydroxy dibenzotriazole mixture;
the fire retardant agents are at least one selected from the group consisting of magnesium hydroxide, aluminum hydroxide, phosphorus-containing compounds and hydroxide nitrogen fire retardant agents.

4. The non-PVC type calendered polyolefin plastic film of claim 2, further including laminated plastic sheet structure via two or more than two layers of the film stacked one on top of another.
